(19) United States
(12) Patent Application Publication
(10) Pub. No.: US 2005/0144821 A1
(43) Pub. Date: Jul. 7, 2005

(54) Printing surface preparation methods and apparatus incorporating same

(76) Inventors: Daniel A. Griesemer, Kaysville, UT (US); Jeffery R. Hunsaker, Kaysville, UT (US)

Correspondence Address: PATE PIERCE & BAIRD, 215 SOUTH STATE STREET, SUITE 550, PARKSIDE TOWER, SALT LAKE CITY, UT, 84111, US

(21) Appl. No.: 10/983,148

(22) Filed: Nov. 4, 2004

Related U.S. Application Data
(60) Provisional application No. 60/517,711, filed on Nov. 6, 2003.
(60) Provisional application No. 60/546,572, filed on Feb. 19, 2004.

(51) Int. Cl. G09F 13/18

(52) U.S. Cl. 40/546

(57) ABSTRACT

A method for preparing a surface of a substrate such as a polymer, glass, and the like to receive one or more images applied thereto. The method may include selecting a substrate having a surface, abrading a portion of the surface, and printing an image comprising a graphic, text, or some combination thereof on the abraded surface. The substrate may be masked to protect selected areas from abrasion. Additionally, if necessary, the substrate may be cleaned after the abrasion to improve the adherence of the image to the abraded surface.

### RELATED APPLICATION

This application claims the benefit of U.S. Provisional Patent Application Ser. No. 60/517,711, filed Nov. 6, 2003 and entitled “METHODS FOR PREPARING A RECEIVING SURFACE FOR AN IMAGE,” and U.S. Provisional Patent Application Ser. No. 60/546,572, filed Feb. 19, 2004 and entitled “NOVEL APPARATUS FOR REMEMBRANCE OF A DECEASED HUMAN OR ANIMAL,” which are incorporated herein by reference.

### BACKGROUND

1. Field of the Invention

The present invention relates to apparatus and methods for applying an image to a surface and, more particularly, to novel methods for preparing a surface to receive an image reproduced thereon and apparatus created using the same.

2. The Background Art

Mankind has been applying images to surfaces for millennia. In fact, some of the earliest known historical records have been found in the form of images applied to cave walls. As humanity has developed, the process of applying images or characters to surfaces has likewise advanced from manual methods to apparatus and methods including the printing press, silk screening, computer controlled printing processes, and the like.

For about the past 500 years, the printing press has been one of the primary methods for applying or reproducing characters, text, and simple images on the display surface of a substrate. As appreciated, a printing press may include one or more trays holding type comprising blocks of raised, individual letters. These trays may be locked in relation to a printing table whereby allowing ink to be applied thereto. A printing substrate may be inserted between the inked type and a press plate. Sufficient force may be applied to the press plate to ensure adequate transfer of the ink from the type to the display surface of the substrate.

After releasing the applied pressure, the substrate is generally removed from the press. An important characteristic of the printing press is that the surface of the substrate is generally impressed with the type. This may result in a unique highlighting around one edge of the substrate, while a shadow may appear at the opposite edge. This characteristic or quality is typically referred to as “sparkle,” which is usually not found in other known printing techniques, methods, or processes.

Although somewhat similar to the printing press, flexography is another technique that was developed by those skilled in the art to apply or reproduce an image on a surface of a substrate. Flexography typically involves one or more flexible rubber plates removably secured to a printing cylinder. Ink or other printing media may be applied to the one or more rubber plates. The cylinder may roll over a surface of a substrate, thereby transferring the “test” or image engraved in the one or more of the rubber plates to the surface of the substrate.

Another advancement in the printing arts developed by those skilled in the art involves the process or technique of Gravure printing—a form of intaglio printing. In practicing Gravure printing, wells or cells are generally etched into a block or portion of a substance (e.g., copper, steel, wood, or the like). An ink or printing media may then be applied to the block. Excess ink or printing media may then be removed from the surface of the block and a printing substrate applied. A significant disadvantage to Gravure printing methods, as well as other known techniques and processes of etched printing, is that they are generally expensive, time-consuming, and not readily adaptable to short-run printing.

In screen printing (e.g., silk screening), ink may pass through a porous stencil to the surface of a substrate material therebelow. Screen printing allows reproduction of an image having multiple colors. Screen printing apparatus and methods usually include a porous screen material mounted to a frame. A stencil of an image is generally reproduced on at least a portion of the porous screen material. A receiving surface of a substrate may be placed under the portion of the screen displaying the image and a color of ink may be applied to the stencil on the top of the screen. The ink may be spread across the porous screen material to encourage at least some of the ink to pass through the porous material and onto the receiving surface of the substrate.

Several stencils are usually required when attempting to reproduce a single multi-colored image, whereas each stencil is generally color specific. Accordingly, the number of stencils typically correspond to the number of colors included in the image being printed or reproduced on the receiving surface of the substrate.

Since the early twentieth century, further developments in the printing art have included offset printing techniques, which have served as an important developing technology for large-scale, commercial printing. During a “pre-press” stage, an image for reproduction may be designed and undergo layout procedures. An image may then be transferred to a printing plate and then placed onto a printing cylinder. Based on the principle of immiscibility (i.e., the inability to mix or become homogeneous) and the respective relationship between water and oil (e.g., grease), a negative image may be transferred to an intermediate cylinder and a positive image may be transferred to a printing substrate. As appreciated by those skilled in the art, offset printing is generally considered to be a complex and time-consuming process.

Printing technologies are presently experiencing rapid growth and development. For example, the hardware and printing apparatus have recently advanced in the areas of ink delivery, as well as size and quality of the printed images. Ink delivery, as defined herein, may include dot matrix, ink jet (i.e., piezo-electric), continuous ink jet (CIJ), laser print, and many other types of delivery methodologies.

A further advancement in the printing art involves techniques and methods associated with digital printing or reproduction. In digital printing, an image in electronic format (e.g., computer file) is communicated to one or more print heads of a printer. Digital printing traditionally involves hardware and software transmitting one or more electronic signals causing ink to be discharged through a delivery nozzle of a print head. Through precision control, a relatively high quality image and/or text may be reproduced on the surface of the substrate. Digital printing methods permit the reproduction of an image comprising text, picture, or some combination thereof in one or more colors.

Paper (i.e., pulp products) has been a traditional and important substrate used for printing. Other printing substrates may include, for example, vinyls, corrugated boards, foam-core boards, fluted polypropylene, styrenes, polycarbonates, glass, and wood. As appreciated, several of these substrates present restrictive challenges or physical difficulties to receiving a printed image and/or maintaining a durable printed image. These challenges or difficulties may include insufficient permanence of an image due to the characteristics and qualities of the substrate, lighting and refraction of an image reproduced on a substrate, insufficient adhesion between an image and a substrate, emulsifying agents, bonding agents, durability, aesthetic characteristics, and the like. As appreciated by those skilled in the art, these challenges may translate into problems or complications affecting printing speed, production time, wasted printing materials (e.g., substrate, ink, etc.), greater inventories of printing materials, difficulty in modifying images, meeting customer-tailored printing needs, and the inability to accommodate short-run printing.

Those skilled in the art have made various attempts to address many of the challenges existing between image reproduction and the physical limitations of various substrates used for printing or reproducing an image. For example, various types of bonding agents and emulsifying agents have been developed to assist in facilitating the application or reproduction of an image to a receiving surface of a substrate. Laminating image technologies, film-coating image processes, and silk screening techniques have been developed by those skilled in the printing art for use by the printing industry to assist in retaining an image relative to a substrate surface. The previous attempts to address issues related to image reproduction have largely focused on altering the physical properties of the inks used in the printing process and using chemicals or other agents to increase the adhesion properties between an image and a receiving surface of a substrate.

What is needed in the printing art are techniques and apparatus for preparing a substrate surface to facilitate image reproduction and application. Such methods and apparatus may enhance durability, aesthetic appeal, printing production speed, economy of substrate printing, and permit printing on substrates which has never before been possible. Such methods and apparatus are disclosed herein.

### BRIEF SUMMARY AND OBJECTS OF THE INVENTION

A primary object of the present invention is to provide novel apparatus and methods for preparing a surface of a substrate to receive one or more printed images.

It is also an object of the present invention to provide novel apparatus and methods for preparing a surface of a substrate to enhance the durability of the images applied thereto.

It is another object of the present invention to provide novel apparatus and methods for preparing a surface of a substrate to facilitate the aesthetic appeal of the images applied thereto.

It is yet another object of the present invention to provide novel apparatus and methods for preparing a surface of a substrate to enhance backlighting of images applied thereto.

Additionally, it is an object of the present invention to provide novel apparatus and methods for preparing a surface of a substrate to enhance the three-dimensional effects generated in an image applied thereto.

It is a further object of the present invention to provide novel apparatus and methods for preparing a surface of a substrate selected from a group including glass, wood, metal, polycarbonates, mirrored surfaces, plastic, ceramic materials, marble, gypsum materials, plaster materials, cementatious materials, resin-based materials, fiber-based materials, high-density polyethylene materials, stone, acrylic, mesh, and the like.

It is also an object of the present invention to provide novel apparatus and methods for preparing a receiving surface of a substrate to receive one or more images by modifying the physical characteristics of the surface of the substrate to enhance adhesion between the surface and one or more of the images applied thereto.

It is another object of the present invention to provide novel apparatus and methods for preparing a surface of a substrate to receive one or more images through abrasion by one or more abrasive media selected, for example and not by way of limitation, from the group consisting of chemicals, sand, aluminum oxide, silicon carbide, glass beads, garnet, oxide grit (sometimes referred to as slag or “black magic”), walnut shells, plastic pellets, or the like.

It is yet another object of the present invention to provide novel apparatus and methods for preparing a surface of a substrate to receive one or more images which reduces or eliminates the need for whitening selected areas of the receiving surface of the substrate before applying (e.g., reproducing) one or more images thereto.

In addition, it is an object of the present invention to provide novel apparatus and methods for preparing a surface of a substrate to receive one or more images which incorporates a commemorative display including a support base, a storage receptacle, and a substrate having one or more images reproduced thereon consistent with the teachings and methods of the present invention.

Moreover, it is an object of the present invention to provide novel apparatus and methods for preparing a surface of a substrate to receive one or more images wherein the image(s) applied to or reproduced on the surface of the substrate incorporate commemorative images to memorialize a deceased family member, friend, and/or animal (i.e., pet).

It is also an object of the present invention to provide novel apparatus and methods for preparing a surface of a substrate to receive one or more images which incorporates a commemorative display comprising a substrate formed from a material such as, for example and not by way of limitation, bronze, ceramic, metal, wood (e.g., mahogany, oak, cherry, or the like), precious metal (e.g., gold, silver, platinum, or the like), copper, brass, nickel, chrome, pewter, marble, stone, plastic, glass, mirrored substrate, polycarbonate, vinyl, foam core board, polypropylene, resin, high-density polyethylene, any combinations thereof, and the like.

Consistent with the foregoing objects, and in accordance with the invention as embodied and broadly described herein, one presently preferred embodiment of the novel apparatus and methods of the present invention may include the steps of: (1) selecting a substrate having a receiving surface; (2) abrading or roughening at least a portion of the receiving surface of the substrate; and (3) applying text, one or more images, or a combination of both to the abraded portion of the receiving surface of the substrate. Additional steps of one presently preferred embodiment of the present invention may include one or more of the following: (1) masking a portion of the receiving surface before the step of abrading or roughening the surface of the substrate; (2) cleaning the abraded portion of the receiving surface of the substrate; (3) curing the image applied to the abraded surface of the substrate; and (4) applying one or more post-coating materials.

Suitable substrates in accordance with the present invention may include, by way of example and not limitation, paper or pulp products, ceiling tile, corrugated board, foam-core board, polyvinyl chloride, polypropylene, polyethylene, polystyrene, polycarbonate, acrylic, other polymers, fiberglass or other composites, glass, wood, metals, metal alloys, mirrored surfaces, ceramics, marble or other stones, gypsum, plaster, cement, mesh, and the like.

In selected embodiments of the present invention, the step of abrading or roughening at least a portion of the receiving surface of a substrate may comprise the use of one or more conventional techniques and apparatus for blasting at least a portion of the receiving surface using an abrasive media selected, for example and not by way of limitation, from the group consisting of chemicals, sand, aluminum oxide, silicon carbide, glass beads, garnet, oxide grit (sometimes referred to as slag or “black magic”), walnut shells, plastic pellets, or the like.

Furthermore, the application of text, an image, or a combination of both, to the receiving surface of a substrate may comprise application in any suitable manner using any suitable apparatus or mechanism. For example, application of an image to the surface of a substrate, as contemplated herein, may be accomplished by flexography, Gravure printing, screen printing, offset printing, and digital printing using a dot matrix printer, ink jet (i.e., piezo-electric) printer, continuous ink jet (CIJ) printer, laser printer, or the like.

In yet another presently preferred embodiment of the present invention, novel apparatus and methods for preparing a surface of a substrate to receive one or more printed images may include the steps of: (1) selecting a substantially transparent substrate having a front surface and an opposing back receiving surface; (2) abrading or roughening at least a portion of the receiving back surface of the substrate; and (3) applying text, one or more images, or a combination of both to the abraded portion of the receiving surface of the substrate, whereas the image reproduced or applied to the back surface of the substantially transparent substrate is in the proper orientation when viewed through the front surface. Additional steps may include one or more of the following: (1) masking a portion of the receiving back surface of the substantially transparent substrate before the step of abrading or roughening the surface of the substrate; (2) cleaning the abraded portion of the receiving surface of the substrate; (3) curing the image applied to the abraded surface of the substrate; and (4) applying one or more post-coating materials.

In certain embodiments of the present invention, the step of abrading or roughening the receiving back surface of a substantially transparent substrate may increase the refraction imposed by the substrate on light traveling therethrough. That is, light passing through the substrate may be redirected in a variety of directions. Such redirections may enhance the image in terms of color quality, brightness, contrast, clarity, depth, three-dimensionality, backlighting, and the like. Moreover, altering the refractive qualities of the substrate may also reduce or eliminate the need to add white background colors or otherwise whiten an image. The light diffusion caused by an abraded or roughened image receiving surface may, accordingly, impart a white appearance to the surface and therefore reduce the need to include white in any image applied to the surface.

One presently preferred embodiment of the novel methods and apparatus of the present invention may include a commemorative display apparatus for remembrance of a deceased family member, friend, and/or animal (e.g., pet) which incorporates a base support member, at least one storage receptacle (e.g., urn, glass case, or the like), and a substrate having text, one or more images, or a combination of both applied or reproduced on at least a portion of a receiving surface of the substrate using novel methods, techniques, and apparatus of the present invention. A retaining member may be provided and configured in such a manner so as to retain the printed substrate in structural relationship to the base support member, the receptacle, or both.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a flow diagram of one presently preferred embodiment of the present invention illustrating one method in accordance with the present invention;

FIG. 2 is a side elevation view of one presently preferred embodiment of the present invention showing an ink droplet exhibiting a relatively low adhesion to a substrate;

FIG. 3 is a side elevation view of one presently preferred embodiment of the present invention illustrating an ink droplet exhibiting a relatively high adhesion to a substrate;

FIG. 4 is a top cross sectional view of one presently preferred embodiment of the present invention showing a substrate having an abraded surface with an image reproduced thereon in accordance with the novel methods of the present invention;

FIG. 5 is a perspective view of one presently preferred embodiment of the present invention illustrating a substantially transparent substrate having an abraded surface with an image reproduced thereon in accordance with the novel methods of the present invention;

FIG. 6 is a top plan view of one presently preferred embodiment of the present invention showing a substrate having an abraded surface with an image reproduced thereon in accordance with the novel methods of the present invention to exhibit a degree of light refraction relative to the abraded portion of the image receiving surface of the substrate;

FIG. 7 is a perspective view of one presently preferred embodiment of the present invention illustrating a tile printed with a marble image in accordance with the novel methods of the present invention;

FIG. 8 is a perspective view of one presently preferred embodiment of the present invention showing a commemorative display apparatus comprising a substrate having an abraded surface with an image reproduced thereon in accordance with the novel methods of the present invention and supportably disposed relative to adjacent, vertically oriented, cylindrical receptacles (e.g., urns);

FIG. 9 is a perspective view of an alternative presently preferred embodiment of the present invention illustrating a commemorative display apparatus including a substrate having an abraded surface with an image reproduced thereon in accordance with the novel methods of the present invention and supportably disposed relative to a support base member and positioned in front of two vertically oriented, cylindrical receptacles (e.g., urns);

FIG. 10 is a perspective view of yet another alternative presently preferred embodiment of the present invention showing a commemorative display apparatus incorporating a substrate having an abraded surface with an image reproduced thereon in accordance with the novel methods of the present invention and supportably disposed in relation to a support base member and positioned in front of two horizontally oriented, cylindrical receptacles (e.g., urns);

FIG. 11 is a perspective view of another alternative embodiment of the present invention illustrating a commemorative display apparatus comprising a substrate having an abraded surface with an image reproduced thereon in accordance with the novel methods of the present invention and supportably disposed in relation to a support base member and positioned behind a horizontally oriented, cylindrical receptacle (e.g., urn);

FIG. 12 is a perspective view of yet another alternative presently preferred embodiment of the present invention showing a commemorative display apparatus comprising a substrate having an abraded surface with an image reproduced thereon in accordance with the novel methods of the present invention and supportably disposed in relation to a support base member acting as a receptacle (e.g., a rectangular urn);

FIG. 13 is a perspective view of another presently preferred embodiment of the present invention illustrating a commemorative display apparatus comprising a substrate having an abraded surface with an image reproduced thereon in accordance with the novel methods of the present invention and supportably disposed in relation to a support base member acting as a receptacle (e.g., an arched urn);

FIG. 14 is a perspective view of another alternative embodiment of the present invention showing a commemorative display apparatus comprising a substrate having an abraded surface with an image reproduced thereon in accordance with the novel methods of the present invention and supportably disposed in relation to a support base member configured to receive a receptacle (e.g., urn) therewithin;

FIG. 15 is a perspective view of yet another presently preferred embodiment of the present invention illustrating a commemorative display apparatus comprising a substrate having an abraded surface with an image reproduced thereon in accordance with the novel methods of the present invention and supportably disposed in relation to a support base member whereby forming at least a portion of one side of a box-shaped display; and

FIG. 16 is perspective view of another alternative presently preferred embodiment of the present invention showing a commemorative display apparatus comprising a substrate having an abraded surface with an image reproduced thereon in accordance with the novel methods of the present invention and supportably disposed in relation to a support base member providing a triangularly shaped receptacle having an internal periphery sufficient for housing and displaying a folded flag and a drawer sufficient in size for acting as a second receptacle for receiving the ashes of a deceased human or animal or commemorative memorabilia.

### DESCRIPTIONS OF THE PREFERRED EMBODIMENTS

It will be readily understood that the components of the present invention, as generally described and illustrated in the Figures herein, could be arranged and designed in a wide variety of different configurations. Those of ordinary skill in the art will, of course, appreciate that various modifications to the details herein may be made without departing from the essential characteristics of the invention, as described. Thus, the following more detailed description of the embodiments and methods of the present invention, as represented in the Figures, is not intended to limit the scope of the invention, as claimed, but it is merely representative of the presently preferred embodiments of the invention.

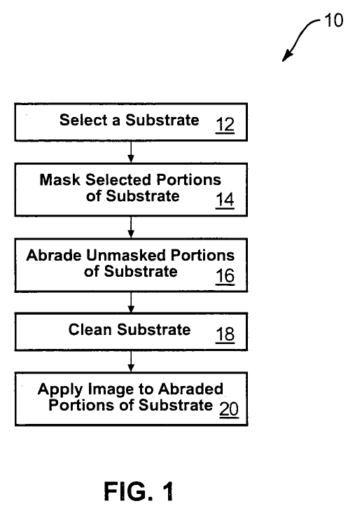

Referring to FIG. 1, in selected embodiments, a general process 10 for applying an image to a substrate may begin with the selection 12 of a substrate. A substrate may include any material presenting a surface suitable for receiving an image. Suitable substrates may include paper or pulp products, ceiling tile, corrugated board, foam-core board, polyvinyl chloride, polypropylene, polyethylene, polystyrene, polycarbonate, acrylic, other polymers, fiberglass or other composites, glass, wood, metals, metal alloys, mirrored surfaces, ceramics, marble or other stones, gypsum, plaster, cement, mesh, and the like. A substrate material may be selected to provide any desired characteristic. For example, a substrate may be selected to provide an aesthetic appeal, transparency, structural strength or some other utility, and the like.

Once a substrate is selected 12, the substrate may be masked 14 to protect or shield various portions thereof. The step of protecting a portion of the receiving surface of the substrate from exposure to the abrasive process may include the application of a chemically resistant layer, the use of appropriately positioned tapes or stencils, and the like. Masking materials may include silicone (e.g., when an acidic chemical is being applied as an abrasive medium), the use of appropriate tapes (i.e., masking tape), contact paper, vinyl, rubber, or the like.

In selected embodiments, the substrate may provide its own masking 14. That is, one surface of a substrate may shield or protect another surface of the substrate. If desired, the step of masking 14 a portion of the receiving surface of the substrate may be omitted, while the entire surface of the substrate may be used for reproducing (e.g., printing) text, one or more images, or a combination of both.

The portion of the substrate where an image is to be reproduced (e.g., printed), in accordance with one presently preferred embodiment of the present invention, may be abraded or roughened 16. Abrading 16 may be accomplished by any conventional process which rubs, erodes, etches, files, grinds, blasts, chips, or otherwise mechanically or chemically acts to roughen at least a portion of the image receiving surface of the substrate. In selected embodiments, the portions of the substrate that are unprotected by the masking 14 may be the only portions of the substrate that are abraded 16. Alternatively, the entire image receiving surface substrate may be abraded 16. In still other embodiments of the present invention, only those portions of the receiving surface of the substrate to which abrading action is specifically applied may be roughened 16.

An abrasive media used to abrade 16 may include chemicals, sand, aluminum oxide, silicon carbide, glass beads, garnet, oxide grit (sometimes referred to as slag or “black magic”), walnut shells, plastic pellets, or the like. Chemicals used as the abrasive media in preparing a receiving surface of a substrate may include conventional solvents or other compounds in either liquid or solid form.

The abrasive media, as contemplated herein, may be applied in any suitable method. Suitable methods may include, for example but not by way of limitation, application by hand, under pressure (e.g., sandblasting, bead blasting, pellet blasting, or the like), by a mechanical abrading device (e.g., belt sander, pad sander, grinder), and the like. A pressurized system for applying the abrasive media may include a media screen, media delivery system (e.g., pressure pot, siphon blaster, handheld blaster, recycling blaster), blast nozzle (e.g., ceramic, carbide), compressor, blast cabinet, and dust collector. The size or grit of the abrasive media used during abrading 16 may be selected in view of the type of substrate selected 12, the desired depth of roughening, and the desired aesthetic qualities of the finished substrate.

If desired or seemingly necessary, additional treatments may be applied to the substrate. For example, additional abrasion, flame treatment, heat treatment, a corona treatment, bonding agents, sealing agent, paint, or the like may be applied. In selected embodiments, a chemical etching or dissolving may soften a previous mechanical abrasion.

In one presently preferred embodiment of the novel methods of the present invention, the step of cleaning 18 the substrate may include the steps of applying a cleaning material selected from water, air, or suitable solvent and the removing the masking applied to at least a portion of the receiving surface of the substrate. The cleaning material may be applied by hand or under pressure. The cleaning material may be left in contact with the abraded substrate surface for any length of time as desired or appropriate to accommodate the level of cleaning required or desired. Suitable cleaning solvents may include, for example, alcohol (e.g., isopropyl alcohol), ketone (e.g., acetone), organic solvents, hydrocarbons, chlorinated solvents, terpenes, and the like, or combinations thereof. As appreciated, conventional power cleaning mechanisms (e.g., ultrasonicator) may be employed to clean the abraded receiving surface of the substrate. If a substrate is sufficiently clean after the abrading process 16, the cleaning step 18 may be omitted from the overall process.

Once cleaned 18, text, one or more images, or a combination thereof (“image”) may be applied 20 to the receiving surface of the substrate. An image in accordance with the present invention may be applied by any suitable printing process. For example, application of an image to the surface may be accomplished by flexography, Gravure printing, screen printing, offset printing, and digital printing using a dot matrix printer, ink jet printer, continuous ink jet printer, laser printer, or the like. In one presently preferred embodiment of the present invention, digital printing is the presently preferred process of reproducing text, one or more images, or a combination of both on the receiving surface of the substrate.

As contemplated herein, an image may be any combination of graphics (e.g. photographs, paintings, sketches, logos, digital creations, etc.), backgrounds, and/or text. For example, in selected embodiments, an image may consist solely of a photograph. In other embodiments, an image may be a photograph coupled with text in a selected font. In still other presently preferred embodiments, an image may consist solely of text. In yet other presently preferred embodiments of the present invention, an image may be a compilation, superposition, or mixing of various sub images, which themselves may include any combination of graphics, backgrounds, and/or text.

Several technologies for image printing may be suitable for use in accordance with the present invention. In selected embodiments, such technologies may be digital and may include, dot matrix printing, ink jet printing, laser printing, and the like. Macroprinters and microprinters, which allow for a wide range of image sizes, may be used. In one presently preferred embodiment of the present invention, an inkjet printer manufactured by Nur Macroprinters, Lod, Israel may be used for digitally printing the image on the receiving surface of the substrate. However, the use of any inkjet printer is contemplated to fall within the spirit and scope of the present invention. Likewise, a variety of inks may also be used, and colors are also contemplated to fall within the scope of the present invention. For example, and not by way of limitation, 4-color, 6-color, 8-color, and other multi-color inks, as well as inks that are curable by heat and/or light (e.g., ultraviolet light), may be used when reproducing an image on the receiving surface of the substrate. As appreciated, different inks may provide any array of curing options, quality, and aesthetic appeal.

The application of text, one or more images, or a combination of both 20 to the abraded portion(s) of a substrate prepared in accordance with the novel methods of the present invention may enhance the ease of manufacture, durability, and aesthetic appeal of the images and the substrate. For example, images prepared in accordance with the present invention may have improved adhesion between the ink forming the image and the substrate, color retention, clarity, depth, fade resistance, etc., and better survive harsh environments including variations in weather, humidity, temperature, lighting, and the like.

Additionally, the present invention contemplates and supports the use of a greater range of image application and printing technologies. For example, a broader range of inks may be used. Moreover, a greater range of substrates may be used. Accordingly, substrates that have hitherto been adverse to receiving an image printed thereon, may easily be printed in accordance with the novel methods of the present invention.

If desired, after an image is applied 20, additional treatments, sealers, or coatings may be applied to assist in protecting the durability of the image reproduced on the receiving surface of the substrate. For example, in one embodiment, a polyester coating may be applied to the receiving surface of the substrate using a sublimation process.

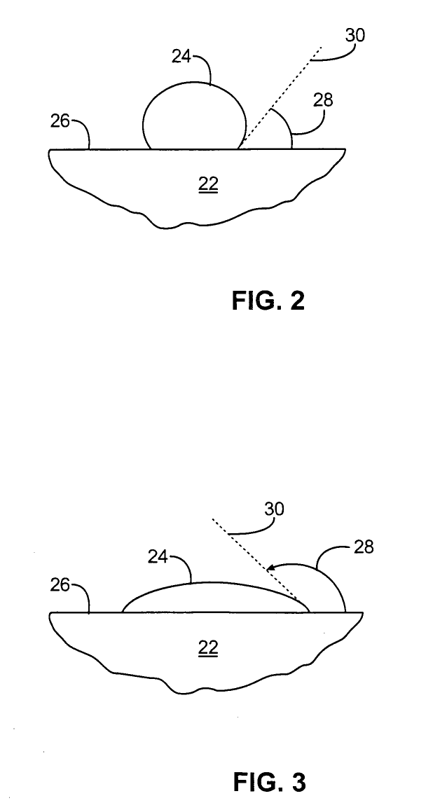

Referring now to FIGS. 2 and 3, in selected embodiments, abrading 16 the receiving surface 26 of a substrate 22 may increase the durability or adhesion of one or more images to the substrate by increasing the tendency of the ink 24 forming the image to spread following application there of to the receiving surface 26 of the substrate 22. The extent to which ink 24 spreads after application to a substrate 22 is an indication of surface tension.

Surface tension of liquids is an important physical characteristic which determines the shape of a liquid on a surface 26. Surface tension may be described as the ratio of the surface force to the length across which the force acts.

The adhesive force between a liquid 24 (e.g., drop of ink 24) and a solid (e.g., substrate 22) may be described by the contact angle 28. The contact angle 28 between a substrate 22 and a liquid 24 may be determined by a line 30 drawn tangent to the liquid 24 at the receiving surface 26 of the substrate 22. The contact angle 28 may be used to determine the “wetting” properties of the interface between a liquid 24 and a solid (e.g., the substrate 22). When the contact angle 28 is less than ninety degrees, the interface may be referred to as having a low degree of wetting. A low degree of wetting may, in turn, indicate poor adhesion between the liquid 24 and solid (e.g., the substrate 22). When the contact angle 28 is greater than ninety degrees, the interface may be referred to as having a high degree of wetting. This may result in greater spreading of a liquid 24 across the solid (e.g., the substrate 22) and may indicate a greater adhesion between the liquid 24 and solid 22.

In printing, certain substrates 22 (e.g., glass, plastic, polycarbonate, and the like) may have a receiving surface 26 which is uniformly smooth and generally non-porous. This may result in an undesired small contact angle 28 when an ink droplet 24 is applied to the substrate 22. The undesired contact angle 28 may, in turn, indicate poor adhesion between the ink 24 and substrate 22. This may result in an inability to apply an image to a substrate or significantly reduced durability of the reproduced image.

Also in printing, certain substrates 22 (e.g., some types of wood, textiles, and the like) may be excessively porous. This may result in an undesirably large contact angle 28 when an ink droplet 24 is applied to the substrate 22. The large contact angle 28 may result in such large wetting that the ink 24 is completely spread out or absorbed into the substrate 22. This greatly increased adherence between ink 24 and substrate 22 may result in a longer durability of the image. However, it may also result in poor quality of image. For example, poor sharpness, tone, color, etc. may result in the final image reproduced on the receiving surface 26 of the substrate 22.

As contemplated herein, the present invention may be used to alter the physical nature of substrate surfaces to combat the ill effects of surface tension between the ink 24 and the substrate 22. Control over the ill effects of surface tension may be had by modifying the surface characteristics of a substrate 22 to allow for desirous changes in the contact angle 28. For example, the effective porosity of a substrate may be increased though abrasion 16 until the contain angle 28 between a substrate 22 and the ink 24 applied thereto is greater than ninety degrees.

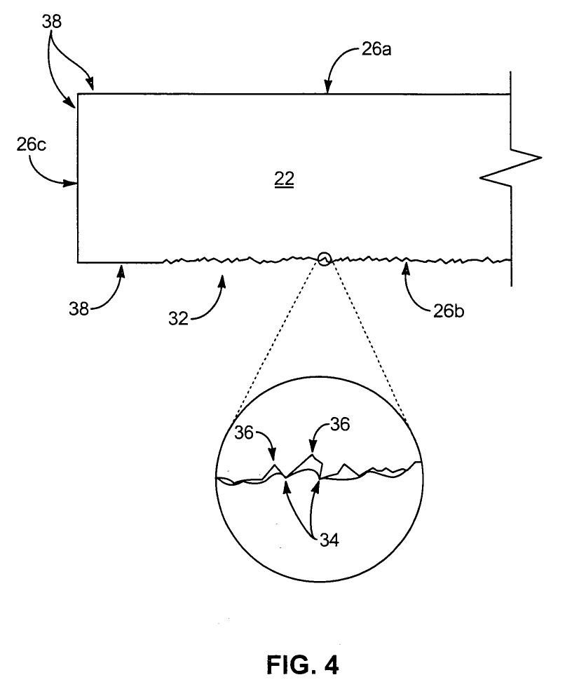

Referring now to FIGS. 2-4, a substrate 22 may have one or more substrate surfaces 26, which may include a front surface 26a, a back surface 26b, and opposing edge surfaces 26c. In one presently preferred embodiment of the present invention, at least a portion 32 of the back surface 26b of the substrate 22 may be abraded 16. Abrasive action may produce a surface 26 that is roughened to form a landscape comprising peaks 34, valleys 36, pits 36, cracks 36, and the like. Other portions 38 of the back surface 26b of the substrate 22 that were masked 14 or where abrasive action was not directed, may maintain a substantially smooth surface.

It will be appreciated, however, that the present invention is generally directed to preparing a receiving surface of a substrate for receiving and maintaining an image by means of abrading the portion of the surface to receive the image. Thus, it is contemplated herein that at least a portion of a front surface of a substrate may be abraded in accordance with the novel methods of the present invention and an image reproduced (e.g., printed) thereon.

The peaks 34 and valleys 36 created in the substrate 22 of one presently preferred embodiment of the present invention may have a variety of heights and depths. Accordingly, the peaks 34 and valleys 36 formed in the back surface 26b of the substrate 22 may increase the surface area of a substrate 22 and create an effective porosity. This porosity may tend to increase the contact angle 28 between droplets of ink 24 and the substrate 22. Additionally, the porosity may provide an array of nooks and crannies where ink 24 may settle. Much of the ink 24 so situated is in the shadow of neighboring peaks 34. Such peaks 34 may prevent the ink 24 from being scraped off by objects passing or scraping along the back receiving surface 26b of the substrate 22. To this end, the durability and resistance to wear exhibited by the ink 24 and substrate 22 combination may be increased.

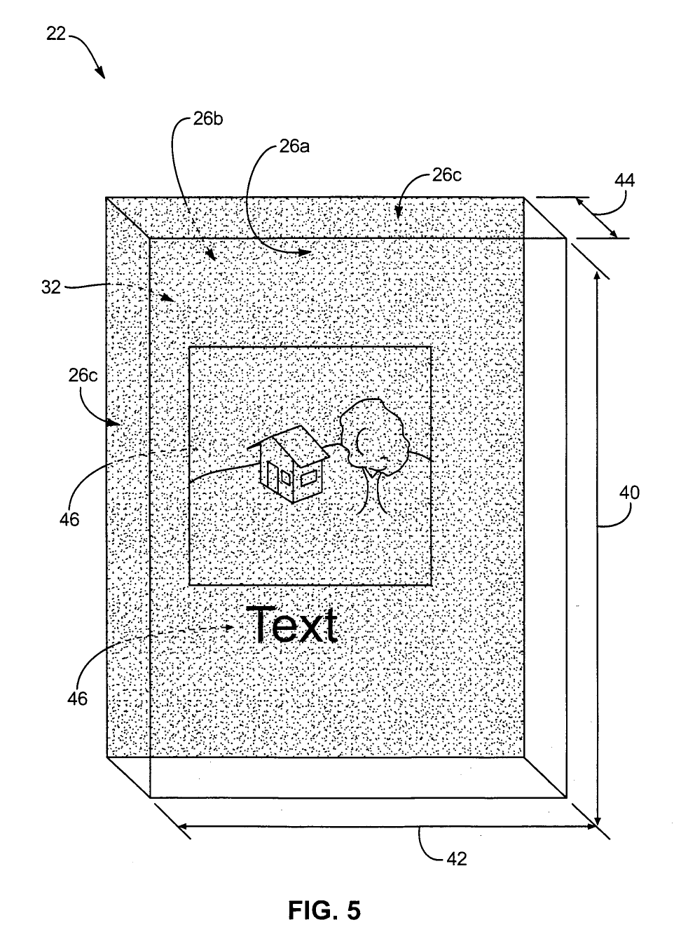

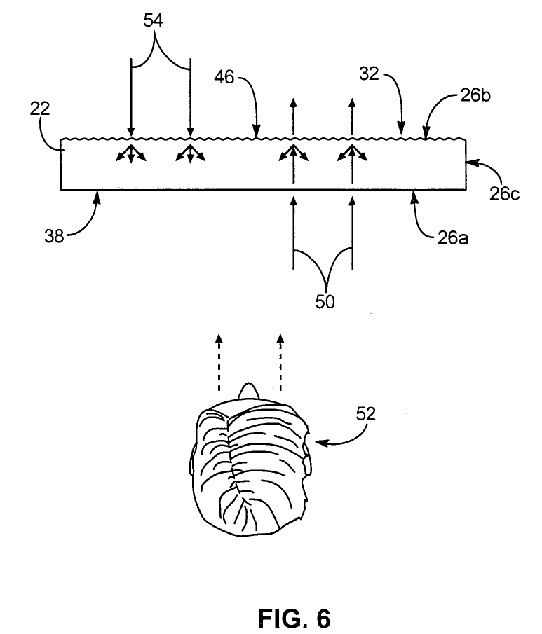

Referring now to FIGS. 5 and 6, in selected presently preferred embodiments of the present invention, a substrate 22 may comprise a pane of a substantially transparent material (e.g., glass, polycarbonate, etc.). The substrate 22 may have any suitable dimensions. For example, in one embodiment, the substrate 22 may have a height 40 of about ten (10) inches, a width 42 of about eight (8) inches, and a thickness 44 of about one quarter of an inch. It will be readily understood by those skilled in the art that the dimensions and sizes disclosed herein are to be viewed as exemplary of the principles of the present invention, and not as restrictive to any particular structure, geometrical shape, or size for implementing those principles.

Before abrading, the front surface 26a, a portion of the back surface, 26b, and the side edges 26c of the substantially transparent substrate 22 may be masked to avoid roughening of these surfaces. The substrate 22 may then be placed and secured upon a blasting work area. In one presently preferred embodiment of the present invention, the unmasked portions of the substrate 22 may be abraded using a high pressure application of sand with a grit in the dimension range of about 80 to about 200. The sandblasting may be applied for a duration of time appropriate to produce a desired texturing on the non-masked portion of the back surface 26b of the substrate 22. In general, the longer the abrading process 16, the rougher the resulting texture in the back surface 26b.

Once the abrading 16 has been completed, the masking may be removed from the portion of the front surface 26a and side edges 26c edges of the substantially transparent substrate 22. The substrate 22 may then be cleaned 18. In selected embodiments of the presently preferred methods and techniques of the present invention, cleaning 18 may be done by applying pressurized air followed by an application of a chemical solvent (e.g., isopropyl alcohol). For example, the contact time of the isopropyl alcohol may be between about one and about two minutes. Alternatively, the isopropyl alcohol may be allowed to evaporate from the surfaces 26 of the substrate 22.

Once cleaned, the substantially transparent substrate 22 may be placed or positioned for printing on the flatbed of a printer in such a manner so as to receive one or more printed images 46. In selected embodiments, the printer used may be an inkjet printer manufactured by Nur Macroprinters. In other embodiments, other printers or printing methods may be used. In general, any suitable printer may be used in accordance with the present invention. Similarly, a variety of inks, and colors may be used in accordance with the present invention. For example, four-color, six-color, eight-color, and other multi-color inks that are curable by heat or light (e.g., ultraviolet light) may be used when printing an image 46 on the prepared portion of the receiving back surface 26b of the substrate 22.

In selected embodiments of the present invention, the image 46 applied to the back surface 26b of the substantially transparent substrate 22 may be oriented so as to be viewed through the font surface 26a of the substrate. For example, any text 48 included as part of the overall reproduced image 46 may be written backward from the perspective of the printer so that the finished product, when viewed through the front surface 26a of the substrate 2 may be properly oriented for reading comprehension.

By reproducing (e.g., printing) the desired image 46 on the back surface 26b of the substantially transparent substrate 22, the image 46 may be better protected than an image printed on the front of a substrate. In general, the front surface 26a of a substrate 22, or the like, positioned for display is often the most handled. Accordingly, by placing the image 46 on the back surface 26b of the substantially transparent substrate 22, the image 46 may be seen though the front surface 26a of the substrate, but not accessible to being touched through contact with the front surface 26a.

Additionally, by positioning the image 46 on at least a portion of the back surface 26b of the substantially transparent substrate 22 to be viewed though the front surface 26a, the refractive qualities produced by the abraded portions 32 of the back surface 26b may be fully enjoyed and realized. That is, the front surface 26a may be smooth and flat to provide a classic polished finish. However, the roughened portions 32 of the back surface 26b of the substrate 22 reflect portions of the front light 50 back to a viewer 52 and redirect and scatter back light 54. In certain embodiments of the present invention, reflected front light 50 and refracted back light 54 enhance the overall aesthetic appeal of the reproduced image 46 and give the image 46 an almost three-dimensional appearance. In addition, the light refractory qualities of the roughened portions 32 of the back surface 26b of the substrate create a white accepting media for the image 46. This white accepting media for the image 46 may be referred to as a subtractive ink printing process or subtractive image reproduction process.

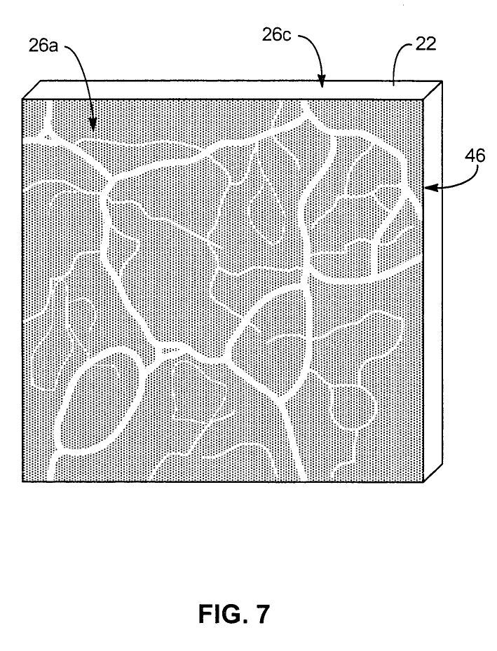

Referring now to FIG. 7, an alternate presently preferred embodiment of the present invention is shown as including an image 46 that may imitate a naturally occurring material such as stone, wood, and the like. For example, in some presently preferred embodiments, a substrate 22 may have an image 46 of “marble” applied thereto. In such embodiments, the marble image 46 may be applied to either the front or back surface 26a, 26b of the substrate 22 using the novel methods and techniques of the present invention. In general, when transparent substrates 22 (e.g., glass, polycarbonate, etc.) are used, the marble image 46 may be applied to the back surface 26b to be view through the front surface 26a, thereby facilitating the physical characteristics and aesthetic attributes enhanced by the refractive qualities of light which interact with the printed image. Alternatively, when an opaque substrate 22 (e.g., ceramic) is used, the marble image 46 may be applied to the front surface 26a to be viewed directly.

It is further contemplated by the methods and apparatus of the present invention that specific portions of an entire image may be reproduced on more than one substrate, wherein when positioned relative to each other, a complete image may be reproduced for viewing. In this manner, one presently preferred embodiment of the present invention may include several substrates (e.g., tiles), each having an abraded surface with an image reproduced thereon in accordance with the novel methods of the present invention, that are disposed relative to each other as to reproduce an overall image defined as the combination and placement of each of the printed substrates (e.g., tiles).

Referring now to FIG. 8, in one presently preferred embodiment of the present invention, a commemorative display apparatus 56 is shown including a substrate 22 having an abraded surface with an image 46 reproduced thereon in accordance with the novel methods of the present invention and supportably disposed relative to a support base member 60 and adjacent, vertically oriented, cylindrical receptacles 58. For example, in selected embodiments, the substrate 22 printed with an image 46 may be coupled to the container 58 functioning as an urn for receipt of the remains of a human or animal.

The practice of cremation (i.e., application of flame, either directly or in an oven, to reduce a deceased body to ashes) has been known to mankind for millennia. In fact, cremation was a widely accepted method for disposing of deceased humans. However, by around 400 A.D. cremation was largely replaced by earth burial. Burial remained the overwhelmingly preferred method of disposition of the deceased until around the later-half of the nineteenth century.

In the late eighteen hundreds, crematoriums began to operate in Europe and North America. Today, cremation has again become widely accepted. In Europe and Japan, cremation is practiced by the populace about sixty-five percent and ninety-five percent of the time, respectively. The populace of Canada practices cremation about forty-eight percent of the time. In the United States, cremation is practiced about twenty-seven percent of the time. The rate of cremation in the United States, however, is rapidly increasing. It is expected that by the year 2010 almost forty percent of the deceased will be cremated and by 2025 almost fifty percent of the deceased will be cremated.

Several factors may contribute to the shift from burial to cremation. For example, cremation is less expensive. Cremation also uses less land and may raise fewer environmental concerns. Moreover, cremation may be perceived as less emotional and more convenient for the survivors. Ashes of the deceased may be strewn in multiple locations (e.g., ocean, mountains, locales associated with childhood or the like). Cremation may also allow for the ashes to be divided among multiple family members, if desired.

For the buried, a headstone, cross, or other monument may be placed at or substantially near the burial site. Typically, a monument may have text, graphics, or some combination of graphics and text engraved thereon. Monuments often serves as tools for reflection, remembrance, love, respect, and the like for family members and friends of the deceased.

In the practice of cremation, it is common to place the burned remains or ashes into a receptacle or storage container 58. Such containers 58 are often referred to as urns 58. Typically, an urn 58 may be held at the residence of a family member or within a specialized vault called a mausoleum. Aside from the various sizes, shapes, and colors, urns 58 have remained largely unchanged for the past hundred years.

Urns 58 may be obtained in various sizes, shapes, colors, and the like. However, these customizations are largely unsuccessful in invoking a more personalized feeling of remembrance, respect, love, and the like for the deceased family member, friend, or animal (e.g., pet). Moreover, when ashes are scattered following cremation, there is no final resting place for the deceased. That is, there may be no specific place where a survivor may go to reflect and obtain emotional comfort in view of his or her loss.

Combining a commemorative display apparatus 56 that may function as an urn 58 for receipt of the ashes of a human or animal, together a substrate having an abraded surface with an image 46 reproduced thereon in accordance with the novel methods of the present invention may provide a visual stimulus for invoking specific feelings of remembrance for a deceased family member, friend, or animal. In selected embodiments, a commemorative display 56 for cremation ashes may include a support base member 60, one or more receptacles 58, and a substrate 22 printed with an commemorative image 46 according to the novel methods of the present invention.

The one or more receptacles or containers 58 associated with a commemorative display apparatus 56 of the present invention for storing the ashes of the deceased may be formed of any suitable material. Suitable materials may include metals, metal alloys, polymers, woods, and the like. The one or more containers 58 may also be configured having any suitable or desired shape. Suitable shapes may include rectangular volumes, cylinders, pyramids, spheres, unconventional shapes, and the like. The one or more containers 58 may have any suitable storage capacity, whereas storage capacity may vary dependant on the size of the deceased. For example, a receptacle or container (e.g., urn) 58 for a deceased human may be substantially larger than a receptacle 58 for a deceased animal (i.e., cat).

In certain embodiments of the commemorative display apparatus 56 of the present invention, the image 46 reproduced on the substrate 22 may include a photograph of a deceased person or pet, a medley of photographs commemorative of a special event or experience (i.e., wedding, birth of a child, etc.), poetry or other textual verse, and the like. A commemorative display apparatus 56 may also include a plaque 62 inscribed with additional text (e.g., the deceased's name, rank, title; the couple's name and date of marriage; name a child and date born, etc.).

The substrate 22 for use with the commemorative display apparatus 56 of the present invention may be selected to provide a particular look. That is, certain colors and material types are generally considered more appropriate than others for formal uses. Substrates 22 that may be suitable for a commemorative display 56 may include metals such as gold, silver, platinum, copper, brass, nickel, chrome, pewter, and bronze, ceramics, woods such as mahogany, oak, cherry, and the like, marble, polymers, glass, mirrored materials, and the like.

In one presently preferred embodiment of the present invention as shown in FIG. 8, a commemorative display apparatus 56 may be formed by securing two receptacles (e.g., urns) 58 on a support base member 60. A substrate 22 having an image 46 reproduced thereon in accordance with the novel methods of the present invention may be supportably disposed between the two urns 58. For example, respective grooves or slots may be formed in the surface of the urns 58 to maintain a desired orientation of the substrate 22 relative thereto. A plaque 62 containing additional text, imagery, or a combination of both may be secured to the support base member 60. Preferably, the base support member 60 is formed of a substantially rigid material such as, for example, wood. The two receptacles (e.g., urns) 58 may be vertically oriented relative to the support base member 60 and configured having a cylindrical shape defining an internal periphery sufficient for retaining at least a portion of the remains of a human or animal. In one presently preferred embodiment, the substrate 22 is glass, and the plaque 62 is engraved with the name of the person or animal whose remains are to be stored in the receptacles (e.g., urns) 58.

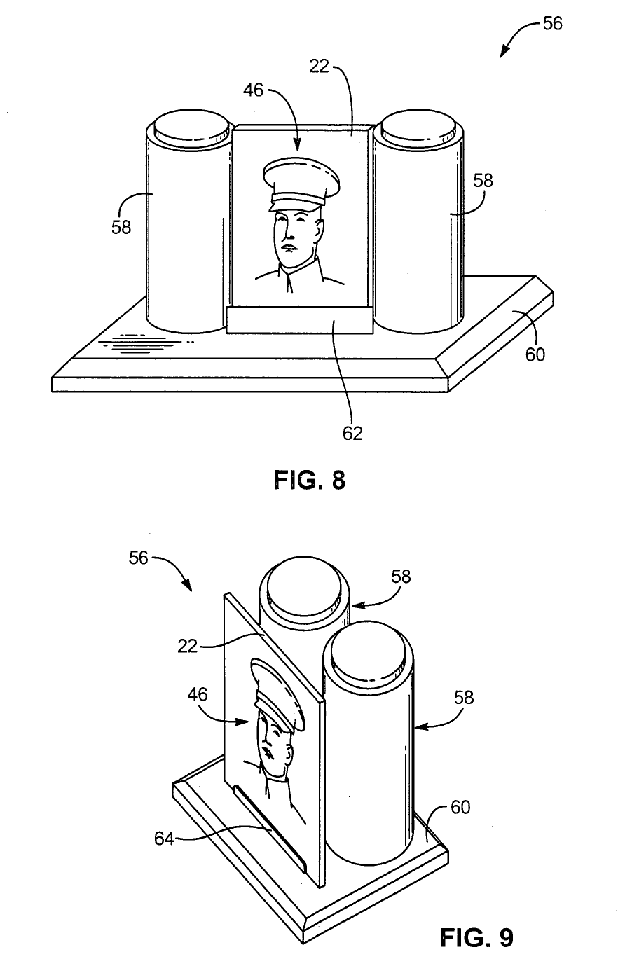

Referring now to FIG. 9, in selected alternate embodiments of the present invention, a commemorative display apparatus 56 may include a retaining member (i.e., bracket) 64 disposed relative to the support base member 60 so as to adequately secure a substrate 22 having an image 46 reproduced thereon in accordance with the novel methods of the present invention in a desired display position with respect to a base 60. The base support member 60 may also support one or more receptacles (e.g., urns 58). Preferably, the base support member 60 may support two vertically oriented, cylindrical, metal urns 58 positioned behind the substrate 22. The receptacles 58, in combination, are preferably formed having an internal periphery sufficient for containing the entire remains of a human or animal.

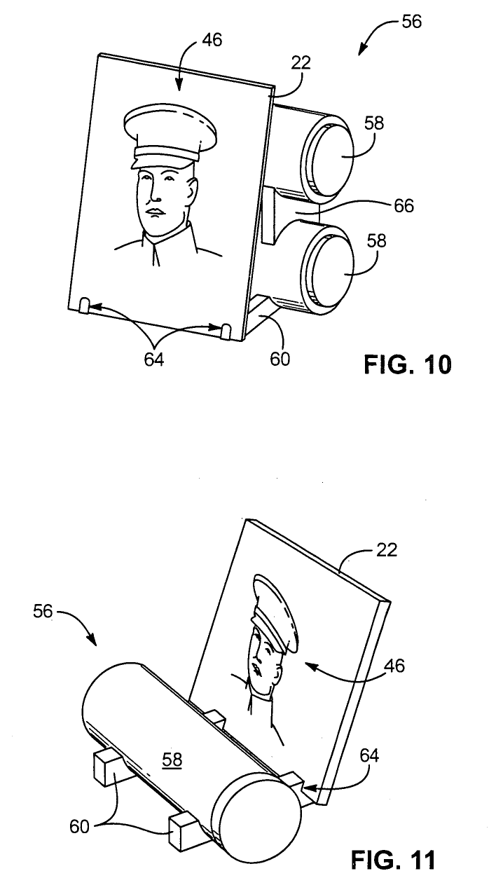

Referring now to FIGS. 10 and 11, any suitable orientation between a receptacle 58 and a substrate 22 may be employed which are herein contemplated to be within the scope of the present invention. For example, in selected embodiments, a commemorative display apparatus 56 is illustrated as including a substrate 22 having an abraded surface with an image 46 reproduced thereon in accordance with the novel methods of the present invention. The substrate 22 is supportably disposed in relation to a support base member 60 and positioned in front of two horizontally oriented, cylindrical receptacles (e.g., urns) 58, as shown in FIG. 10. Moreover, the support base member 60 may be configured in such a manner so as to support a first receptacles 58 above a second receptacle.

Referring specifically to FIG. 11, another presently preferred embodiment of a commemorative display apparatus 56 of the present invention is shown comprising a substrate 22 having an abraded surface with an image 46 reproduced thereon in accordance with the novel methods of the present invention. The substrate 22 may be supportably disposed in relation to a support base member 60 and positioned behind a horizontally oriented, cylindrical receptacle (e.g., urn) 58. As appreciated, the support base member 60 may be configured in such a manner so as to support additional receptacles 58, if desired.

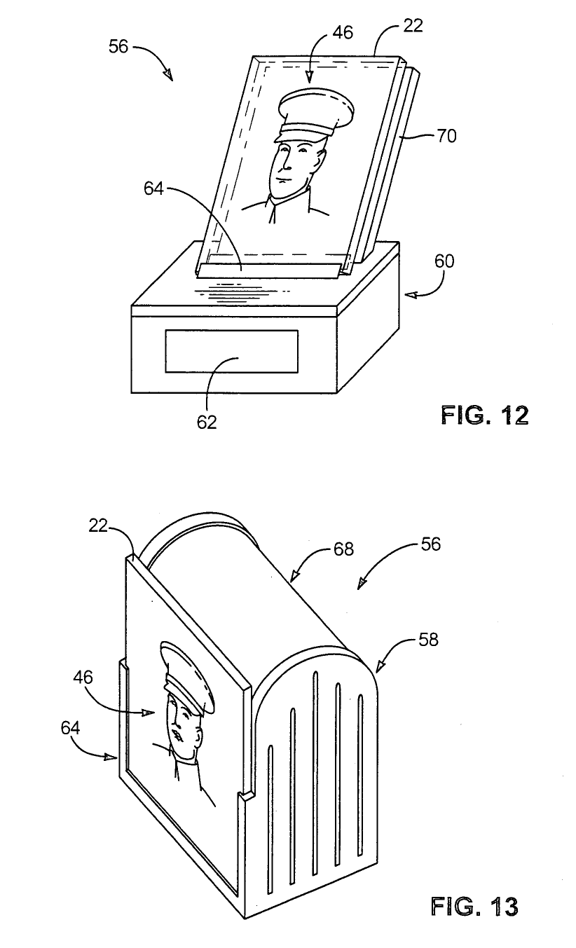

Referring now to FIG. 12, in selected embodiments, a commemorative display apparatus 56 may include a substrate 22 having an abraded surface with an image 46 reproduced thereon in accordance with the novel methods of the present invention and supportably disposed in relation to a support base member 60 acting as a receptacle (e.g., urn, container for memorabilia, or the like). In one presently preferred embodiment of the present invention, the support base member 60 may be configured having a substantially rectangular shape. It will be appreciated by those skilled in the art that any other geometric shape or configuration is contemplated herein as falling within the spirit and scope of the present invention as exhibited in the multiplicity of embodiments shown in the attached Figures.

In selected embodiments, the commemorative display 56 may include a bracket 64 to secure the substrate 22 in a desired display position relative to the receptacle 58 and, in addition, a plaque 62 containing descriptive text, if desired. In addition, a light source 70 may be positioned relative to the substrate 22 so as to provide back-lighting to the image 46. Whereas, the light source 70 may be supportably disposed relative to the support base member 60 or, in the alternative, may engage the substrate 22. In one presently preferred embodiment of the present invention, the electronics of the light source 70 may be housed within the support base member 60.

As shown in FIG. 13, a receptacle (e.g., urn) 58 in accordance with the present invention may have any suitable shape. For example, the receptacle 58 may be generally rectangular with an arched top 68. If desired, a bracket 64 may be formed as part of the receptacle 58 to facilitate securement of the substrate 22 having an abraded surface with an image 46 reproduced thereon in accordance with the novel methods of the present invention.

A receptacle (e.g., urn) 58, in accordance with the present invention, may have any suitable finish. In selected embodiments, the finish may be selected based on the material from which the receptacle 58 is formed. For example, a receptacle 58 formed of metal or metal alloy may have a gold, silver, chrome, etc. finish color applied thereto. On the other hand, a receptacle 58 formed of wood may have a finish comprising a stain, sealer, or some combination thereof.

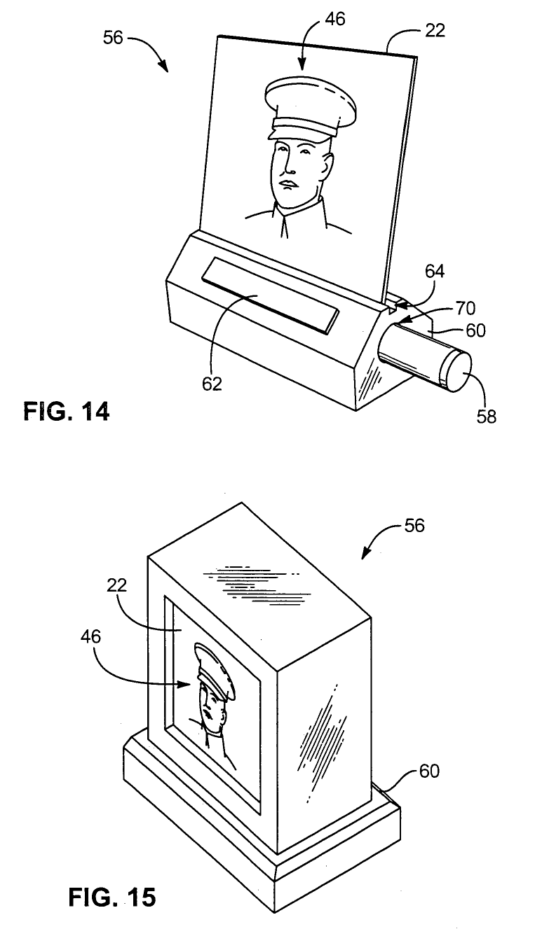

Referring now to FIG. 14, in selected embodiments, the base support member 60 may be configured in such a manner so as to receive a receptacle (e.g., urn) 58 within an internal chamber 70 having a dimensional periphery sufficient for receiving the receptacle 58 therein. In one presently preferred embodiment, a cylindrical receptacle (e.g., urn) 58 may be introduced horizontally within the internal chamber 70 formed in the base support member 60.

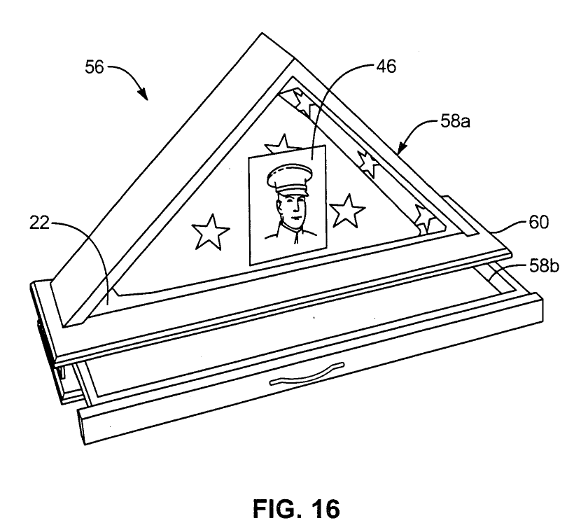

Yet another presently preferred embodiment of the present invention is shown in FIG. 15, wherein a commemorative display apparatus 56 comprises a substrate 22 having an abraded surface with an image 46 reproduced thereon in accordance with the novel methods of the present invention and supportably disposed in relation to a support base member whereby the substrate 22 forms at least a portion of one side of a box-shaped display. Preferably, the substrate 22 is incorporated into the structural part of the support base member 60.

In some presently preferred embodiments, the substrate 22 may be substantially transparent. In such embodiments, the commemorative display apparatus 56 may be used as a light box. That is, one or more lights may be positioned within the display apparatus 56 to provide back light to illuminate the image 46 applied to the substrate 22. Alternatively, the substrate 22 may be opaque. For example, in one embodiment, the substrate 22 may be formed of wood. In such embodiments, the commemorative display apparatus 56 may be used as an urn for storing the cremated remains of a human or animal.

Referring now to FIG. 16, an alternative presently preferred embodiment of the present invention is shown comprising a commemorative display apparatus 56 having a substrate 22 having an abraded surface with an image 46 reproduced thereon in accordance with the novel methods of the present invention and supportably disposed in relation to a support base member 60 providing a triangularly shaped receptacle 58a having an internal periphery sufficient for housing and displaying a folded flag and a drawer sufficient in size for acting as a second receptacle 58b for receiving the ashes of a deceased human or animal or, in the alternative, for introducing commemorative memorabilia.

In selected embodiments, a substrate 22 printed with an image 46 in accordance with the present invention may be incorporated into a commemorative display 56 including a container 58a of a different type. For example, if desired, a container 58 included within a commemorative display 56 may be sized and shaped to receive a flag therein.

In one embodiment, a container 58 for a flag may have a generally triangular shape sized to receive the flag folded in the traditional triangular manner. One side of the container 58 may be formed of a transparent material 22 allowing one to see the flag kept therewith. If desired, the transparent material 22 may comprises a substrate 22 in accordance with the present invention. Accordingly the transparent material 22, or some portion thereof, may be masked 14, abraded 16, cleaned 18, and printed 20, as discussed hereinabove.

Consistent with the foregoing, it will be appreciated that novel methods of preparing one or more substrate surfaces of the present invention may increase the wearability and/or permanence of the printed substrate by providing an abraded surface and/or providing an altered physical surface that may be capable of a more permanent bonding with an image printed or transferred by ink. Moreover, by abrading the receiving back surface of a substantially transparent substrate, the reflected front light and refracted back light enhance the overall aesthetic appeal of the reproduced image and give the image an almost three-dimensional appearance. In addition, the light refractory qualities of the roughened portions of the back surface of the substrate create a white accepting media for the image, whereby enhancing the backlighting of images applied thereto.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A method for reproducing an image on a substrate, the method comprising the steps of:
selecting a substrate having a first surface and an opposing second surface;
abrading at least a portion of the first surface; and
reproducing an image comprising at least one of a graphic and text on the abraded portion of the first surface.

2. The method as defined in claim 1, wherein the substrate is a substantially transparent material.

3. The method as defined in claim 1, wherein the substrate is glass or a polymer.

4. The method as defined in claim 1, further comprising the step of masking selected portions of the substrate prior to abrading.

5. The method as defined in claim 1, wherein the step of abrading comprises propelling an abrasive media against the first surface.

6. The method as defined in claim 5, wherein the abrasive media is selected from the group consisting of sand, aluminum oxide, silicon carbide, glass beads, garnet, oxide grit, walnut shells, and plastic pellets.

7. The method as defined in claim 1, further comprising the step of cleaning the substrate after abrading the first surface of the substrate.

8. The method as defined in claim 7, wherein the step of cleaning the substrate comprises the step of applying a cleaning material to the substrate.

9. The method as defined in claim 8, wherein the cleaning material is selected from the group consisting of water, air, and solvent.

10. The method as defined in claim 9, wherein the solvent is selected from the group consisting of alcohol, ketone, organic solvents, hydrocarbons, chlorinated solvents, and terpenes.

11. The method as defined in claim 1, further comprising the step of applying an additional surface treatment after abrading the first surface of the substrate, the additional surface treatment selected from the group consisting of chemical etching, flame treatment, corona treatment, heat treatment, bonding agent application, sealing agent application, and painting.

12. The method as defined in claim 1, wherein the image comprises a graphic and text.

13. The method as defined in claim 12, wherein the graphic is a compilation of one or more photographs.

14. The method as defined in claim 1, wherein the step of reproducing the image comprises digitally printing an image comprising a graphic and text on the roughened portion of the first surface so the text is properly oriented for reading when viewed through the second surface.

15. A method for reproducing an image on a substrate, the method comprising the steps of:
selecting a substrate having a first surface and an opposing second surface, the substrate being substantially transparent to light within the visible spectrum traveling through the first and second surfaces;
abrading at least a portion of the first surface; and
reproducing an image comprising at least one of a graphic and text on the abraded portion of the first surface.

16. A method for reproducing an image on a substrate, the method comprising the steps of:
selecting a substrate formed of substantially transparent material, the substrate having a first surface and an opposing second surface;
abrading at least a portion of the first surface;
cleaning the substrate; and
printing an image comprising at least one of a graphic and text on the abraded portion of the first surface so that the image is properly oriented for reading when viewed through the second surface.

17. The method as defined in claim 16, wherein the substantially transparent material is selected from the group consisting of a polymer and glass.

18. A method for printing an image on a substrate, the method comprising the steps of:
selecting a substrate formed of a substantially transparent material, the substrate having a first surface and an opposing second surface;
propelling an abrasive media against at least a portion of the first surface to form an abraded portion;
cleaning the substrate; and
digitally printing an image comprising at least one of a graphic and text on the abraded portion of the first surface so that the image is properly oriented for reading when viewed through the second surface.

19. An apparatus comprising:
a substrate;
the substrate having a first surface and an opposing second surface;
the substrate having at least a portion of the first surface abraded; and
an image comprising at least one of a graphic and text printed on the abraded portion of the first surface.

20. The apparatus as defined in claim 19, wherein the substrate comprises a substantially transparent material.

21. The apparatus as defined in claim 20, wherein the substantially transparent material is selected from the group consisting of glass and a polymer.

22. The apparatus as defined in claim 19, further comprising a light source disposed relative to the substrate so as to provide back-lighting of the image.

23. The apparatus as defined in claim 19, wherein the image includes a graphic comprising a photograph.

24. The apparatus as defined in claim 19, wherein the image comprises both a graphic and text and wherein the graphic and text are properly oriented for respected viewing and reading through the second surface.

25. The apparatus as defined in claim 19, further comprising a receptacle supportably disposed in relation to the substrate.

26. The apparatus as defined in claim 25, wherein the receptacle comprises an urn shaped and sized to house cremated remains of a human.

27. The apparatus as defined in claim 25, wherein the receptacle comprises an urn shaped and sized to house cremated remains of an animal.

28. The apparatus as defined in claim 25, wherein the receptacle is configured to have a triangular shape having a size sufficient to house a triangularly folded flag.

29. An apparatus comprising:
a substrate being substantially transparent to light within the visible spectrum;
the substrate having a first surface and an opposing second surface;
the substrate having at least a portion of the first surface abraded; and
an image comprising at least one of a graphic and text printed on the abraded portion of the first surface.

30. A commemorative display apparatus, comprising:
a support base member;
a first receptacle secured to the support base member to extend upward therefrom;
a second receptacle secured to the support base member to extend upward therefrom, the second receptacle being spaced apart from the first receptacle;
a substrate formed of a substantially transparent material, the substrate having a first surface and a second surface, positioned substantially parallel and opposite the first surface, the substrate having at least a portion of the first surface abraded, and wherein the substrate extending between the first and second receptacles; and
an image comprising at least one of a graphic and text printed on the abraded portion of the first surface of the substrate.

31. The commemorative display apparatus as defined in claim 30, wherein the substrate is formed of glass.

32. The commemorative display apparatus as defined in claim 30, wherein the first receptacle has a generally cylindrically shape.

33. The commemorative display apparatus as defined in claim 30, wherein the first receptacle is formed of metal having a finish color selected form the group consisting of gold, silver, and chrome.

34. The commemorative display apparatus as defined in claim 30, wherein the substrate is generally rectangular in shape.

35. The commemorative display apparatus as defined in claim 30, wherein the substrate has left, right, top, and bottom edges.

36. The commemorative display as defined in claim 35, wherein the first receptacle is formed with a groove engaging the left edge of the substrate.

37. The commemorative display apparatus as defined in claim 35, wherein the second receptacle is formed with a groove engaging the right edge of the substrate.

38. The commemorative display apparatus as defined in claim 30, wherein the support base member is formed of wood.

39. The commemorative display apparatus as defined in claim 30, further comprises a plaque engraved with text and secured to the base.

40. The commemorative display apparatus as defined in claim 30, wherein the image comprises at least one photograph.

41. The commemorative display apparatus as defined in claim 30, wherein the image further comprises text.

42. The commemorative display apparatus as defined in claim 41, wherein the text is oriented on the first surface to be viewed for proper reading though the second surface.

43. The apparatus as defined in claim 30, further comprising a light source disposed relative to the substrate so as to provide back-lighting of the image.

44. A commemorative display apparatus, comprising:
a support base member;
a first receptacle formed of metal in a substantially cylindrical shape, the first receptacle being supported by the support base member;
a substrate formed of substantially transparent material, the substrate having a first surface and a second opposing surface, wherein at least a portion of the first surface is abraded;
an image comprising at least one of a graphic and text printed on the abraded portion of the first surface; and
a bracket secured to the support base member and engaging the substrate.

45. The commemorative display apparatus as defined in claim 44, further comprising a second receptacle formed of metal in a substantially cylindrical shape, the second receptacle being supported by the base member.
